(19) United States
(12) Patent Application Publication
(10) Pub. No.: US 2010/0320295 A1
(43) Pub. Date: Dec. 23, 2010

(54) Shower head apparatus with adjustable flow rate arrangement

(76) Inventor: Hoi Kwan Henry Mang, Hong Kong (HK)

Correspondence Address: DAVID AND RAYMOND PATENT FIRM, 108 N. YNEZ AVE., SUITE 128, MONTEREY PARK, CA, 91754, US

(21) Appl. No.: 12/589,264

(22) Filed: Oct. 20, 2009

(30) Foreign Application Priority Data
Jun. 18, 2009 (CN) 200920153386.4

(51) Int. Cl. B05B 1/14

(52) U.S. Cl. 239/562

(57) ABSTRACT

A shower head apparatus includes a shower head and an adjustable flow rate arrangement. The shower head has a head portion, handle portion, and a water passage extended from the handle portion to the head portion for allowing water flowing from the handle portion to the head portion. The shower head further has a front opening slot to communicate with the water passage. The adjustable flow rate arrangement includes a water valve coaxially supported within the water passage, wherein the water valve has a size adjustable water passageway communicating with the water passage for controllably adjusting a flow rate of the water passing through the water passage in responsive to size-change of the water passageway. A thumb actuator extended out of the handle portion of the shower head through the opening slot is provided to selectively adjust the size of the water passageway to control the flow rate of water.

### BACKGROUND OF THE PRESENT INVENTION

1. Field of Invention

The present invention relates to a shower head apparatus, and more particularly to an adjustable shower head for controllably adjusting a water flow rate of the water passing through the shower head.

2. Description of Related Arts

Shower head is commonly used in a bathroom at home or public shower room to guide the water flow for taking a shower. The shower head can distribute water for showering more efficiently by using same amount of water to wet a relatively larger area, so as to save the water for conservation of water resource.

Generally, shower head is connected to hot and cold water supply sources to mix the hot and cold water to a desired shower temperature. A shower switch is adapted for manipulating the water spraying out from the shower head. There is a common type of switch, which is adapted for being pulled to turn on the shower head to start the water flow, and then, being rotated to adjust the water to desired temperature.

However, for the above type of shower head, there is no way to adjust the water amount or flow rate of spraying the showering water. When a user is hoping to have relatively larger amount of water to be delivered in a certain time period for cleaning purpose, the shower head is unable to meet the requirement of needs. It is also wasting water since the user is unable to adjust the shower head to a smaller amount per certain time period either.

Another major type of switch for manipulating the shower head is two tap like switches connecting to a hot water source and cold water source respectively, so that the water temperature is adjusted by rotatably controlling the two switches to mix the hot and cold to a desired temperature. The water flow rate is able to be adjusted via rotating the tap like switches. The user is able to selectively control both of the water temperature and flow rate.

On the other hand, the hot and cold water supply will be mixed in a properly proportion to adjust the desired temperature and then to enter into a single water passage to the shower head. Each time the flow rate of water passing through the shower head is adjusted, the water temperature has to be readjusted through both cold and hot switches. If the user wants to shut off the water while he or she is soaping or shampooing for the conservation of water resources, the water temperature has to be readjusted to mix the hot and cold water to a desired proportion.

The inconvenience of adjusting water temperature makes the user tend to keep the water running until the shower process is completed. It is time consuming and wasting water. Therefore, there exists a great need of a convenient method for adjusting the water flow rate of the shower head, so as to save the water resources.

### SUMMARY OF THE PRESENT INVENTION

A main object of the present invention is to provide a shower head apparatus, which is able to conveniently adjust a flow rate of water spraying out of the shower head.

Another object of the present invention is to provide a shower head apparatus, wherein an adjustable flow rate arrangement is provided at the shower head for adjusting the water flow rate.

Another object of the present invention is to provide a shower head apparatus, wherein the adjustable flow rate arrangement comprises a water valve having a size adjustable water passageway for controllably adjusting the flow rate of the water passing through the water passage in responsive to a size-change of the water passageway.

Another object of the present invention is to provide a shower head apparatus, wherein a thumb actuator and a thumb actuating portion enable the size of the water passageway to be selectively adjusted to control the flow rate of water in by the thumb of the user in one single movement.

Another object of the present invention is to provide a shower head apparatus, wherein the water valve for controlling the water flow rate requires no significant changing of the overall structure of the shower head apparatus, so as to minimize the manufacturing cost.

Another object of the present invention is to provide a shower head apparatus, wherein a control valve of the water valve is coaxially supported within the water passage of the shower head at a position along the axle of the water passage, so as to minimize the overall size of the shower head.

Accordingly, in order to accomplish the above objects, the present invention provides a shower head apparatus, which comprises:

a shower head having a head portion, a handle portion, and a water passage extended from the handle portion to the head portion for allowing water flowing from the handle portion to the head portion, wherein the shower head further has a front opening slot provided at the handle portion to communicate with the water passage; and

an adjustable flow rate arrangement, which comprises:

a water valve coaxially supported within the water passage of the shower head at the handle portion thereof, wherein the water valve has a size adjustable water passageway communicating with the water passage for controllably adjusting a flow rate of the water passing through the water passage in responsive to a size-change of the water passageway; and

a thumb actuator having a valve operating portion extended to the water valve and a thumb actuating portion extended out of the handle portion of the shower head through the opening slot to selectively adjust the size of the water passageway so as to control the flow rate of water.

These and other objectives, features, and advantages of the present invention will become apparent from the following detailed description, the accompanying drawings, and the appended claims.

### BRIEF DESCRIPTION OF THE DRAWINGS

FIG. 1 is a front perspective view of a shower head apparatus according to a preferred embodiment of the present invention.

FIG. 2 is a sectional view of the shower head apparatus according to the preferred embodiment of the present invention.

FIG. 3 is an exploded perspective view of the shower head apparatus according to the preferred embodiment of the present invention.

FIGS. 4A to 4C are top views of a water valve of the shower head apparatus according to the preferred embodiment of the present invention, illustrating different sizes of water passageway.

### DETAILED DESCRIPTION OF THE PREFERRED EMBODIMENT

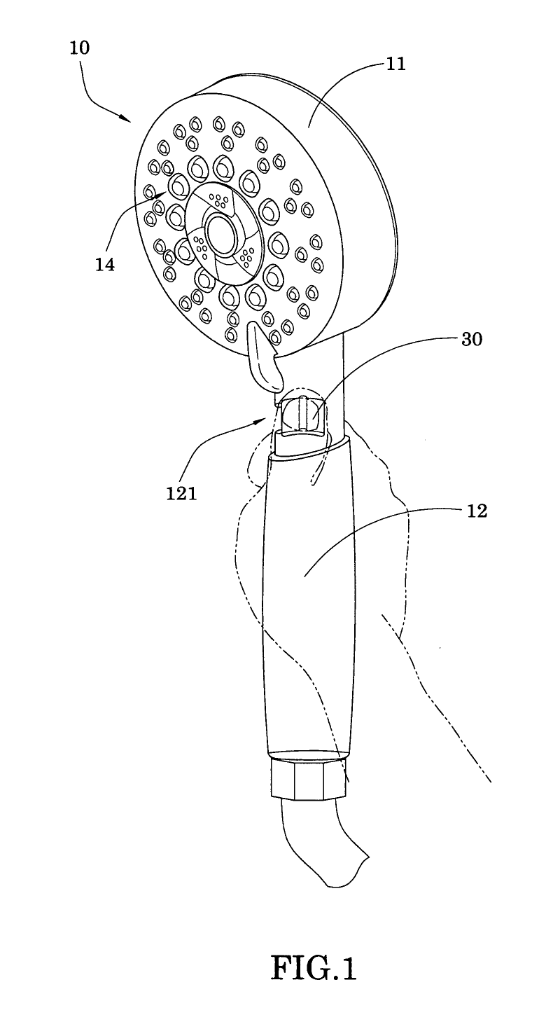

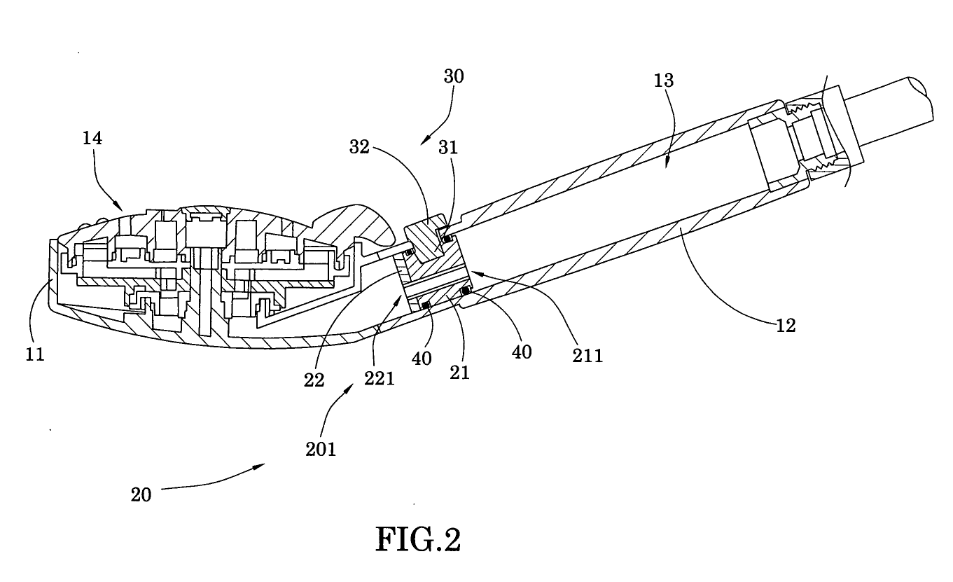

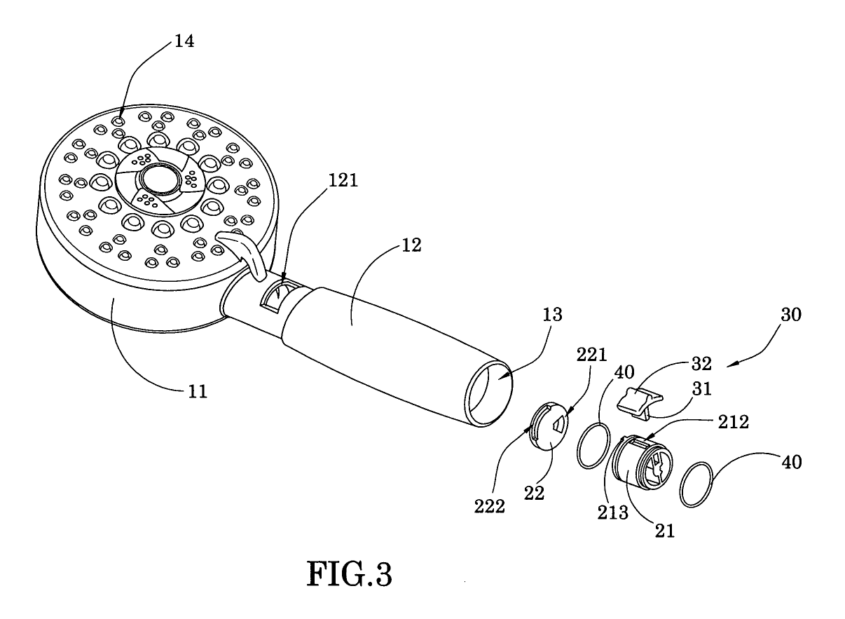

Referring to FIGS. 1 to 4 of the drawings, a shower head apparatus according to a preferred embodiment of the present invention is illustrated, which comprises a shower head 10 and an adjustable flow rate arrangement provided at the shower head 10 for adjusting a flow rate of water passing within the shower head 10.

The shower head 10, which is a hand-held shower head, has a head portion 11, a handle portion 12 extended from the head portion 11, and a water passage 13 extended within the shower head 10 from the handle portion 12 to the head portion 11, so as to deliver water to the head portion 11 for spraying out the water. The shower head 10 further comprises a shower distributor 14 provided at a front side of the head portion 11 for spraying the water from the head portion 11 of the shower head 10. Accordingly, the shower distributor 14 is adapted for adjustably selecting a plurality of water spray patterns regarding to the user's desire.

The adjustable flow rate arrangement comprises a water valve 20 preferably provided at the handle portion 12 of the shower head 10 for selectively adjusting the flow rate while the user holds the handle portion 12 of the shower head 10 for showering. The handle portion 12 of the shower head 10 also has a front opening slot 121 provided at a front side of the handle portion 12 to communicate with the water passage 13.

The water valve 20 is coaxially supported within the water passage 13 of the shower head 10 at the handle portion 12 thereof for controlling the water passing through the water passage 13. The water valve 20 has a size-adjustable water passageway 201 communicating with the water passage 13 for controllably adjusting the flow rate of the water passing through the water passage 13 in responsive to a size-change of the water passageway.

The adjustable flow rate arrangement of the shower head apparatus further comprises a thumb actuator 30 having a valve operating portion 31 extended to the water valve 20, and a thumb actuating portion 32 extended out of the handle portion 12 of the shower head 10 through the front opening slot 121 to selectively adjust the size of the water passageway 201, so as to adjustably control the flow rate of water.

Accordingly, the water valve 20 comprises a valve base 22 coaxially supported within the water passage 13, and a control valve 21 coaxially and rotatably aligning with the valve base 22 in a rotatable manner to define the water passageway 201 through the valve base 22 and control valve 21, such that the size of the water passageway 201 is selectively adjusted in responsive to a rotational position of the control valve 21 with the respect to the valve base 22.

The valve base 22 further has a water through slot 221 aligning with the water passage 13 of the shower head 10, and to form a portion of the water passageway 201 of the water valve 20, so that when the control valve 21 is driven via the thumb actuator 30 to rotate, the water through slot 221 is gradually covered, so as to selectively adjust the size of the water passageway 201 to control the flow rate of water passing through the water valve 20.

The control valve 21 further has a water through channel 211 aligning with the water passage 13 of the shower head 10 and arranged to form another portion of the water passageway 201, such that when the control valve 21 is rotated to entirely align the water through channel 211 with the water through slot 221 of the valve base 22, the water passageway 201 is adjusted at a maximum size for allowing a maximum flow rate of the water entering to the head portion 11 of the shower head 10. When the control valve 21 is rotated to entirely offset the water through channel 211 from the water through slot 221 of the valve base 22, the water passageway 201 is adjusted at a minimized size for blocking the water entering to the head portion 11 of the shower head 10.

In order to conveniently to select the flow rate of water passing through the water passage 13 via selectively adjusting the size of the water passageway 201 of the water valve 20, the control valve 21 has a cylindrical shape for coaxially and rotatably coupling within the water passage 13, so that the flow rate of water can be easily adjusted by rotatably adjusting the size of the water passageway 201 by the rotational position of the control valve 21. In addition, the water through channel 211 is eccentrically formed at the control valve 21 that the two openings of the water through channel 211 are formed at the top and bottom sides of the control valve 21.

Accordingly, the water through slot 221 is eccentrically formed at the valve base 22 that the two openings of the water through slot 221 are formed at the top and bottom sides of the valve base 22. It is worth to mention that the valve base 22 has a disk shape that the valve base 22 is affixed to the handle portion 12 of the shower head 10 within the water passage 13 is an immovable manner.

In other words, the water through slot 221 of the valve base 22 and the water through channel 211 of the control valve 21 are aligned with each other to form the water passageway 201, wherein the water passageway 201 is formed along the axial direction of the water passage 13 of the shower head 10, so as to form at a direction the same as the water flowing direction within the water passage 13.

Accordingly, the valve base 22 coaxially coupling within the water passage 13 has a shape corresponding to the water passage 13 to allow the water can only passing through the water through slot 221 for controlling the water flow rate. The water through slot 221 has an arc-shape and formed eccentrically at the valve base 22 for controllably allowing the water passing therethrough.

The cylindrical shaped control valve 21 has a cross section corresponding to the cross section of the water passage 13 to allow the water only passing through the water through channel 211. The water through channel 211 also has an arc-shaped cross section corresponding to the shape of the water through slot 221 of the valve base 22, so that the water through slot 221 is able to entirely aligning with the water through channel 211 of the control valve 21.

The arc-shaped water through slot 221 and water through channel 211 has a radian angle preferably no larger than 90°, so that the control valve 21 is rotated to entirely offset the water through channel 211 from the water through slot 221 of the valve base 22. The water passageway 201 is adjusted at a minimized size for blocking the water entering to the head portion 11 of the shower head 10, when the thumb actuator 30 is driving the control valve to rotate to completely offset the water through slot 221 and water through channel 211.

The control valve 21 further has an actuation slot 212 formed at the outer circumferential surface of the control valve 21. The valve operating portion 31 of the thumb actuator 30 is coupled with the actuation slot 212 for driving the control valve 21 to rotate, in such a manner that when the thumb actuating portion 32 of the thumb actuator 30 is driven to slide sidewardly, the control valve 21 is driven to rotate within the water passage 13 of the shower head 10 to selectively adjust the size of the water passageway 201 of the water valve 20.

It is worth to mention that the thumb actuating portion 32 of the thumb actuator 30 is protruded out from the front opening slot 121 at the front side of the handle portion 12, so that while a user holds the handle portion 12 of the shower head 10, a thumb of the user is naturally located at the thumb actuating portion 32 of the thumb actuator 30 to select the water flow rate in a one hand or one thumb operable manner, as shown in FIG. 1. The control valve 21 is adapted for being sidewardly rotated via the thumb actuating portion 32 of the thumb actuator 30, which is also design to fit the ergonomic design for easily and conveniently being rotated to select the water flow rate while holding the handle portion 12 of the shower head 10.

As mentioned above, the water valve 20 of the adjustable flow rate arrangement further comprises a guiding arrangement for guiding the control valve 21 to rotate between the a minimized and maximized size of the water passageway 201 positions, wherein the guiding arrangement comprises an arc-shaped sliding track 222 provided at a peripheral edge of the valve base 22 and a sliding member 213 protruded out at a peripheral edge of the control valve 21 to slidably couple with the sliding track 222.

In other words, the guiding arrangement is provided for guiding a rotational movement of the control valve 21 with respect to the valve base 22 by slidably engaging the sliding member 213 with the sliding track 222 at the valve base 22.

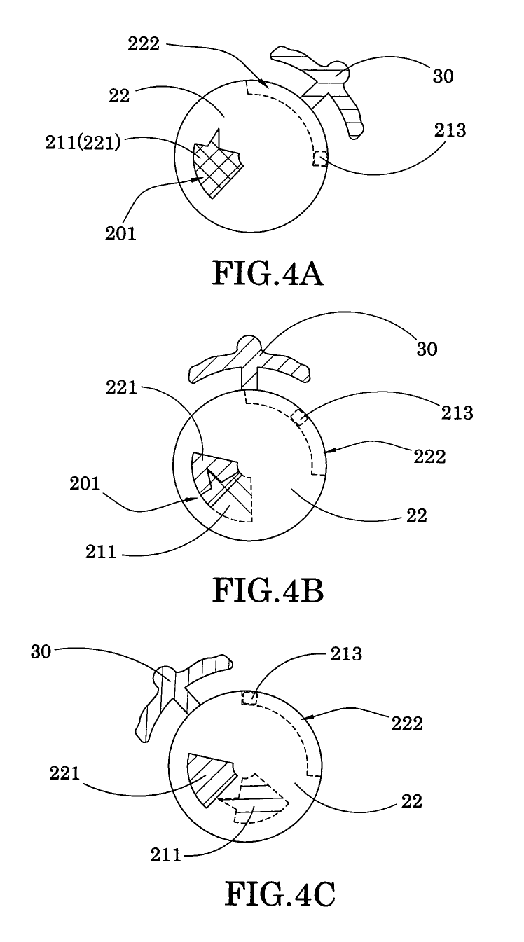

The sliding track 222 has two ends, wherein when the sliding member 213 is guided to slide at one end of the sliding track 222, the water passageway 201 is adjusted at the maximum size thereof, as shown in FIG. 4A. When the sliding member 213 is guided to slide at an opposed end of the sliding track 222, the passageway 201 is adjusted at the minimum size thereof, as shown in FIG. 4C.

Therefore, when the sliding member 213 is guided to slide between the two ends of the sliding track 222, as shown in FIG. 4B, the passageway 201 is adjusted in a partially-opened-partially-closed manner, in such a manner that the water flow rate is controlled via slidably controlling the size of the water passageway 201.

In order to limit that the water can only pass through the water passageway 201 of the water valve 20, the water adjustable arrangement further comprises two sealing rings 40 preferably provided at both upper and lower end portion of the control valve 21 of the water valve 20. The two sealing rings 40 are coaxially mounted at upper and lower ends of the control valve 21 respectively to seal at and bias against an inner wall of the water passage 13 of the shower head 10 so as to prevent the water from leaking through the actuation slot 212 of the control valve 21. In other words, each of the sealing rings 40 is sealed between the outer circumferential surface of the control valve 21 and the inner wall of the water passage 13 of the shower head 10 to ensure the water flowing through the water through channel 211 of the control valve 21 when the control valve 21 is driven to rotate within the water passage 13. Therefore, the sealing rings 40 are capable of enforcing the water passing only through the water through channel 211 to the water through slot 221, so that the water flow rate is able to be efficiently controlled via the size-adjustable water passageway 201.

It is appreciated that the adjustable flow rate arrangement is incorporating with the shower head 10 without alternating the overall structure of the shower head, so that the manufacturing cost is able to be minimized. The water valve 20 for controlling the water flow rate is coaxially supported within the water passage 13, so that the overall size is minimized.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A shower head apparatus, comprising:
a shower head having a head portion, a handle portion, and a water passage extended from said handle portion to said head portion for allowing water flowing from said handle portion to said head portion, wherein said shower head further has a front opening slot provided at said handle portion to communicate with said water passage; and
an adjustable flow rate arrangement, which comprises:
a water valve coaxially supported within said water passage of said shower head at said handle portion thereof, wherein said water valve has a size adjustable water passageway communicating with said water passage for controllably adjusting a flow rate of said water passing through said water passage in responsive to a size-change of said water passageway; and
a thumb actuator having a valve operating portion extended to said water valve and a thumb actuating portion extended out of said handle portion of said shower head through said opening slot to selectively adjust the size of said water passageway so as to control said flow rate of water.

2. The shower head apparatus, as recited in claim 1, wherein said water valve comprises a valve base coaxially supported within said water passage of said shower head, and a control valve rotatably and coaxially aligned with said valve base to define said water passageway through said valve base and said control valve, such that said water passageway is selectively adjusted its size in responsive to a rotational position of said control valve with respect to said valve base.

3. The shower head apparatus, as recited in claim 2, wherein said valve base has a water through slot aligning with said water passage of said shower head and arranged to form a portion of said water passageway that when said control valve is adjustably rotated, said water through slot is gradually covered to selective adjust the size of said water passageway.

4. The shower head apparatus, as recited in claim 3, wherein said water through slot is formed eccentrically at said valve base.

5. The shower head apparatus, as recited in claim 3, wherein said water through slot has an arc-shape with a radian not larger than 90°.

6. The shower head apparatus, as recited in claim 4, wherein said water through slot has an arc-shape with a radian not larger than 90°.

7. The shower head apparatus, as recited in claim 3, wherein said control valve has a water through channel aligning with said water passage of said shower head and arranged to form another portion of said water passageway, such that when said control valve is rotated to entirely align said water through channel with said water through slot of said valve base, said water passageway is adjusted at a maximum size for allowing a maximum flow rate of said water entering to said head portion of said shower head, and when said control valve is rotated to entirely offset said water through channel from said water through slot of said valve base, said water passageway is adjusted at a minimized size for blocking said water entering to said head portion.

8. The shower head apparatus, as recited in claim 6, wherein said control valve has a water through channel aligning with said water passage of said shower head and arranged to form another portion of said water passageway, such that when said control valve is rotated to entirely align said water through channel with said water through slot of said valve base, said water passageway is adjusted at a maximum size for allowing a maximum flow rate of said water entering to said head portion of said shower head, and when said control valve is rotated to entirely offset said water through channel from said water through slot of said valve base, said water passageway is adjusted at a minimized size for blocking said water entering to said head portion.

9. The shower head apparatus, as recited in claim 7, wherein said valve control has a cylinder shape and defines said water through channel being formed eccentrically at said valve control and having an axial direction aligning with a flowing direction of said water towards said head portion of said shower head.

10. The shower head apparatus, as recited in claim 8, wherein said valve control has a cylinder shape and defines said water through channel being formed eccentrically at said valve control and having an axial direction aligning with a flowing direction of said water towards said head portion of said shower head.

11. The shower head apparatus, as recited in claim 8, wherein said water through channel has an arc-shaped cross section with a radian not larger than 90°.

12. The shower head apparatus, as recited in claim 10, wherein said water through channel has an arc-shaped cross section with a radian not larger than 90°.

13. The shower head apparatus, as recited in claim 6, further comprising a guiding arrangement for guiding a rotational movement of said valve control with respect to said valve base, wherein said guiding arrangement comprises an arc-shaped sliding track formed at a peripheral edge of said valve base, and a sliding member protruded from said control valve to slidably engage with said sliding track in such a manner that when said sliding member is guided to slide at one end of said sliding track, said water passageway is adjusted at the maximum size thereof, when said sliding member is guided to slide at an opposed end of said sliding track, said passageway is adjusted at the minimum size thereof, and when said sliding member is guided to slide between said two ends of said sliding track, said passageway is adjusted in a partially-opened-partially-closed manner.

14. The shower head apparatus, as recited in claim 10, further comprising a guiding arrangement for guiding a rotational movement of said valve control with respect to said valve base, wherein said guiding arrangement comprises an arc-shaped sliding track formed at a peripheral edge of said valve base, and a sliding member protruded from said control valve to slidably engage with said sliding track in such a manner that when said sliding member is guided to slide at one end of said sliding track, said water passageway is adjusted at the maximum size thereof, when said sliding member is guided to slide at an opposed end of said sliding track, said passageway is adjusted at the minimum size thereof, and when said sliding member is guided to slide between said two ends of said sliding track, said passageway is adjusted in a partially-opened-partially-closed manner.

15. The shower head apparatus, as recited in claim 12, further comprising a guiding arrangement for guiding a rotational movement of said valve control with respect to said valve base, wherein said guiding arrangement comprises an arc-shaped sliding track formed at a peripheral edge of said valve base, and a sliding member protruded from said control valve to slidably engage with said sliding track in such a manner that when said sliding member is guided to slide at one end of said sliding track, said water passageway is adjusted at the maximum size thereof, when said sliding member is guided to slide at an opposed end of said sliding track, said passageway is adjusted at the minimum size thereof, and when said sliding member is guided to slide between said two ends of said sliding track, said passageway is adjusted in a partially-opened-partially-closed manner.

16. The shower head apparatus, as recited in claim 2, wherein said control valve further has an actuation slot formed at an outer circumferential surface of said control valve for coupling said valve operating portion of said thumb actuator in such a manner that when said thumb actuating portion of said thumb actuator is driven to slide sidewardly, said control valve is driven to rotate within said water passage of said shower head to selectively adjust the size of said water passageway.

17. The shower head apparatus, as recited in claim 7, wherein said control valve further has an actuation slot formed at an outer circumferential surface of said control for coupling said valve operating portion of said thumb actuator in such a manner that when said thumb actuating portion of said thumb actuator is driven to slide sidewardly, said control valve is driven to rotate within said water passage of said shower head to selectively adjust the size of said water passageway.

18. The shower head apparatus, as recited in claim 15, wherein said control valve further has an actuation slot formed at an outer circumferential surface of said control for coupling said valve operating portion of said thumb actuator in such a manner that when said thumb actuating portion of said thumb actuator is driven to slide sidewardly, said control valve is driven to rotate within said water passage of said shower head to selectively adjust the size of said water passageway.

19. The shower head apparatus, as recited in claim 2, wherein said adjustable flow rate arrangement further comprises two sealing rings coaxially mounted at upper and lower ends of said control valve respectively to seal at and bias against an inner wall of said water passage of said shower head.

20. The shower head apparatus, as recited in claim 18, wherein said adjustable flow rate arrangement further comprises two sealing rings coaxially mounted at upper and lower ends of said control valve respectively to seal at and bias against an inner wall of said water passage of said shower head.
